(19) United States
(12) Patent Application Publication
(10) Pub. No.: US 2016/0016823 A1
(43) Pub. Date: Jan. 21, 2016

(54) NATURAL ZEOLITE-NANOHYDROXYAPATITE COMPOUND MATERIAL, METHOD FOR PREPARING SAME AND USE THEREOF FOR REMOVING FLUORIDE FROM WATER

(71) Applicants: Consejo Superior de Investigaciones Científicas (CSIC), Madrid (ES); ADDIS ABABA UNIVERSITY, Addis Ababa (ET)

(72) Inventors: Luis Gómez-Hortigüela Sainz, Madrid (ES); Joaquín Pérez Pariente, Madrid (ES); Isabel Díaz Carretero, Madrid (ES); Yonas Chebude, Addis Ababa (ET)

(73) Assignees: Consejo Superior de Investigaciones Científicas (CSIC), Madrid (ES); Addis Ababa University, Addis Ababa (ET)

(21) Appl. No.: 14/770,679

(22) PCT Filed: Feb. 25, 2014
(86) PCT No.: PCT/ES2014/070141

§ 371 Date: Aug. 26, 2015

(30) Foreign Application Priority Data
Feb. 26, 2013 (ES) P 201330262

(51) Int. Cl. C02F 1/28; B01J 47/00; B01J 47/10; B01J 41/02; B01J 41/10

(52) U.S. Cl. CPC C02F 1/288; B01J 41/02; B01J 41/10; C02F 1/281; B01J 47/10; B01J 47/007; C02F 2101/14

(57) ABSTRACT

The present invention relates to a compound material consisting of a natural zeolite having calcium as an exchangeable cation, in which hydroxyapatite on a nanometric scale is grown in a controlled manner on the surface thereof; to the method by which said compound material is obtained; and to the use thereof for removing fluoride from water in order to make same drinkable. As a result of the aforementioned special characteristics of hydroxyapatite crystals, said material has a very high intrinsic capacity (based on the weight of hydroxyapatite) for removing fluoride. This capacity, combined with the low cost and ease of access to the materials used for preparing same, and with the straightforward nature of the method, means that said material is the perfect candidate for removing fluoride from water having high levels of this contaminant.

### FIELD OF THE ART

The present invention is classified principally in the field of non-metallic mineral products, and of the chemical sector, as it relates to a composite material formed by nanohydroxyapatite crystals grown on the surface of a natural zeolite having calcium as its interchangeable cation, presenting a high capacity of fluoride elimination; and to the method for obtaining the same.

Furthermore, it is also classified in the water treatment sector, within a benign environmental framework due to the use of natural, environmentally-friendly materials, as the characteristics of the composite material and its preparation make it an ideal alternative as treatment for removing of fluoride in water.

### STATE OF THE ART

Water is an essential raw material for the progress of life. The chemical composition of the water from different natural sources constitutes the main factor which determines its purpose; in industry, agriculture or for domestic use (including drinking water). In spite of the fact that the water from the subsoil represents only 0.6% of the water available in the Earth's crust, it represents the main source of drinking water.

The fluoride ion (F⁻) constitutes one of the most abundant anions in subsoil water worldwide. Fluoride is present in rocks and soils of the Earth's crust. In this context, the presence of fluoride in subsoil waters originates fundamentally from the partial dissolution of fluoride-containing minerals, mainly fluorite (CaF₂), cryolite (Na₃AlFPO₆) and fluoroapatite (Ca₅(PO₄)₃F), present in rocks of the subsoil.

The presence of fluoride in drinking water may be beneficial or harmful to health, depending on its concentration. At concentrations of between 0.4 and 1.0 mg/L in water, fluoride is beneficial, particularly in children under 8 years of age, for the calcification of dental enamel. Conversely, a high intake of fluoride may give rise to dental and/or skeletal fluorosis. Thus, the World Health Organization (WHO) established the maximum limit for fluoride concentration in water for human consumption at 1.5 mg/L (WHO, Guidelines for drinking water quality, 1985, Vol. 3, 1-2, World Health Organization, Geneva).

High concentrations of fluoride are commonly present in subsoil waters, where the duration of the contact between the water and the F-rich minerals is greater, especially in North America, in Africa, particularly in the area of the Rift Valley, and in Asia. In Spain, specifically in the northern region of Tenerife, high concentrations of fluoride have also been observed in the water, as have associated cases of fluorosis. Consequently, the development of technologies, preferably of low cost and environmentally friendly, for the elimination of fluoride from the water until a level below that established by the WHO is reached, is currently a vital objective worldwide.

Currently, there exist various technologies for the elimination of fluoride from water; however, there is no widely-accepted agreement as to which is the most suitable. Current technologies include precipitation-coagulation, membrane-based processes, ion-exchange methods, and adsorption methods (S. Jagtap, M. K. Yenkie, N. Labhsetwar, S. Rayalu, Chem. Rev. 112 (2012) 2454-2466).

In the adsorption methods, the fluoride is removed by adsorption in various types of (adsorbent) materials. These methods are the most promising, due to their low cost and ease of operation, high efficiency, easy accessibility, respect for the environment and recyclability of the adsorbents.

The principal question in the implementation of adsorption methods is the selection of the appropriate adsorbent material. The assessment of an adsorbent implies consideration of its adsorption capacity in dilute solutions, pH, elimination time, stability of the adsorbent, its capacity of regeneration, possible interference with other ions, and naturally its cost and availability. A great variety of synthetic and natural materials have been screened, including activated and impregnated alumina, rare-earth oxides, clays and other earth-derived materials, impregnated silica, carbonic materials, calcium-based materials, materials from industrial waste, zeolites or natural biopolymers. However, when the concentration of fluoride in the water drops (real concentrations present in subsoil water are generally below 10 mg/L), many of these materials partially lose their ability to remove fluoride, and are frequently unable to reduce fluoride concentration to below the limit of 1.5 mg/L. Furthermore, they occasionally release potentially harmful species into the water.

One of the most widely-used adsorbents is hydroxyapatite (HAp, Ca₅(PO₄)₃OH), due to its ability to exchange hydroxide ions for fluoride, which has been widely discussed in the literature, due particularly to its low cost and high efficiency. Initial studies proved the ability of HAp to reduce the concentration of fluoride to below 1.5 mg/L. It was also observed that the capacity of HAp in the elimination of fluoride depends on the particle size; the removal capacity increased with a reduction in the size of the particle. The principal mechanism of fluoride elimination by HAp occurs via the isomorphic replacement of hydroxide by fluoride in the crystalline network, due to their identical electric charge and similar ionic radius, linked with the greater stability of fluoroapatite. Taking this mechanism into consideration, the theoretical maximum fluoride removal capacity would be 37.8 mg of F⁻ per g of HAp. However, in the crystalline network of HAp, the hydroxide ions are found in the centre of six-member ring channels, and therefore diffusion via these channels and the resultant isomorphic replacement by fluoride is partially restricted, this explaining the greater intrinsic removal capacity observed with smaller particle sizes. In this regard, the reduction in the size of the HAp particle to a nanometric scale should entail an appreciable improvement in the removal capacity. In fact, high elimination capacities have been observed for nanohydroxyapatites (nHAp), with values generally between 1 and 2 mg of F⁻ per g of HAp. In all cases, these capacity values are considerably lower than the theoretical maximum of 37.8 mg of F⁻ per g of HAp, this being a replacement of less than 10% of the hydroxide present in the HAp, once again highlighting the diffusional problems.

However, the nanometric size of these HAps implies that their use in real applications may give rise to significant pressure drops during the filtration processes, which represents a serious drawback. To avoid this, Sundaram and co-workers prepared materials comprised of HAp and biopolymers such as chitosan or kitin (C. Sundaram, N. Viswanathan, S. Meenakshi, BioresourceTechn. 99 (2008), 8226-8230. 2. C. Sundaram, N. Viswanathan, S. Meenakshi, J. Haz. Mater. 172 (2009) 147-151), which may be prepared in any way desired, yielding reasonable removal capacities.

All these studies show that HAp is able to remove fluoride to below the limit established by the WHO, although its capacity is low in comparison with the theoretical maximum, due to diffusional restrictions. A reduction in the particle size will entail an improvement in the intrinsic removal capacity of the HAp. The present invention is focused on this context, it being a method for the preparation of nanohydroxyapatite with an extremely high elimination capacity, employing a natural zeolite as a source of calcium and a HAp growth modulating agent, thus giving rise to a compound zeolite-HAp material.

Zeolites are crystalline microporous aluminosilicates with a defined three-dimensional structure formed by Si and Al tetrahedra. The three-dimensional arrangement of these units gives rise to the formation of highly diverse microporous structures. The incorporation of Al⁺³ into the inorganic zeolitic network generates a negative charge in the network which is compensated by the presence of cations in the pores and/or cavities. These species (extra-reticular cations) are not strongly bonded with the framework, and may therefore be interchanged with other cations. One of these interchangeable cations is calcium.

Zeolites may be of natural origin, found in volcanic areas worldwide, or may be synthesised in the laboratory. In accordance with the topology of the channel/cavity systems of the zeolitic structures, these materials may release the Ca²⁺ present in their cavities by controlled cationic interchange with the environment. This is due to the peculiar topology of the zeolitic structures with channels of a relatively small size which cause the diffusion of the Ca²⁺ cations to the exterior of the crystal to be slow. Therefore, zeolites possessing Ca²⁺ as an interchangeable cation and with small pore channels may be employed as slow and controlled Ca²⁺ ion liberators, which could give rise to HAp crystallisation in the presence of PO₄³⁻ ions and under suitable conditions, with a very small, controllable particle size, which would entail an increase in its capacity to remove fluoride. There exists in the literature a precedent for the crystallisation of HAp on the surface of a synthetic zeolite, in this case on zeolite A (LTA), employing the Ca²⁺ from the interior of the zeolite, extracted by interchange with NH₄⁺ ions (Y. Wanatabe, Y. Moriyoshi, Y. Suetsugu, T. Ikoma, T. Kasama, T. Hashimoto, H. Yamada, J. Tanaka, J. Am. Ceram. Soc. 87 (2004) 1395-1397; Y. Wanatabe, T. Ikoma, Y. Suetsugu, H. Yamada, K. Tamura, Y. Komatsu, J. Tanaka, Y. Moriyoshi, J. Eur. Cer. Soc. 26 (2006) 469-474). The main application of this procedure for the preparation of HAp on the surface of zeolite is to achieve a total coating of the surface in order that the radioactive ions or other contaminants are retained inside the same, with no risk of being liberated (Y. Wanatabe, T. Ikoma, Y. Suetsugu, H. Yamada, K. Tamura, Y. Komatsu, J. Tanaka, Y. Moriyoshi, J. Eur. Cer. Soc. 26 (2006) 481-486; Y. Wanatabe, T. Ikoma, H. Yamada, Y. Suetsugu, Y. Komatsu, W. Stevens, Y. Moriyoshi, J. Tanaka, ACS Appl.Mater.Inter. 1 (2009) 1579-1584).

### DESCRIPTION OF THE INVENTION

### Brief Description of the Invention

In a first aspect, the invention relates to a composite material of natural zeolite-nanohydroxyapatite, hereinafter the material of the invention, comprised of:
A natural zeolite, possessing Ca²⁺ as an interchangeable cation and whose structure contains at least one channel whose smallest diameter is less than 0.41 nm, and
HAp crystals with a total percentage of interchangeable hydroxides of at least 10%.

A second object of the invention consists of the method for obtaining the material of the invention, hereinafter the method of the invention, which comprises a controlled cationic interchange of the Ca²⁺ of the natural zeolite, and the subsequent precipitation of HAp in the presence of a source of phosphorus on the surface of the zeolite.

A third object of the invention consists of the use of the material of the invention for the removal of fluoride from water.

### DETAILED DESCRIPTION OF THE INVENTION

The present invention is based on the observation that the formation of HAp crystals of nanometric size, with a high capacity for the elimination of fluoride is particular in that it employs a natural zeolite, rich in calcium and presenting small-pore channels, if it is used as a source of calcium and a HAp growth modulating agent in the presence of PO₄³⁻ ions and under specific conditions of preparation (see examples 2 to 11), enabling the obtaining of a natural zeolite-HAp composite material, of use in the elimination of fluoride from water (see examples 12 to 24), and further presenting the capacity of regeneration (see examples 24 and 25).

The technical advantages of the composite material described in the present invention as a fluoride adsorbent are:
a) It uses a natural mineral resource with a very low cost as a source of Ca.
b) It maximises the efficacy of the elimination of fluoride on the basis of its P content, which represents the item with the highest economic cost of those employed, thanks to the optimisation of the intrinsic capacity (on the basis of the weight of P or HAp) of the HAp prepared, implying that the proportion of HAp which is effective in the anionic interchange (the external part) is high in comparison with the inert (internal) part.
c) It precludes the problems of drops in pressure during filtration in the aforementioned real applications, associated with the size of the HAp particle, as the HAp crystals are affixed to the surface of the zeolite.
d) It presents a high capacity of elimination of fluoride at low concentrations (around 5 mg/L) and at natural pH values of water, thanks to the control of the size of the HAp, due to the peculiar topology of the natural zeolites employed, with small-pore channels, where the Ca interchange is restricted.

As used in the present invention, the term “natural zeolite” relates to a crystalline microporous aluminosilicate with a defined three-dimensional structure, formed by Si and Al tetrahedra sharing vertices of oxygen and comprising a blend of calcium and other cations as interchangeable cations. The structural topology of the natural zeolite must possess at least one system of channels whose smallest diameter is less than 0.41 nm (as defined in the database of the International Zeolite Association: http://www.iza--structure.org/databases/)

The first object of the present invention consists of a natural zeolite-nanohydroxyapatite composite material, with a high capacity of adsorption of fluoride and regeneration capacity, comprising:
a natural zeolite possessing, as an interchangeable cation, a content of calcium between 0.25 and 13% by weight, and whose structure possesses at least one channel whose smallest diameter is less than 0.41 nm, and
HAp crystals with a total percentage of interchangeable hydroxides of at least 10%.

A specific example of a natural zeolite of these characteristics is a natural stilbite zeolite from the mines in Ethiopia, which features a composition by weight of 29.50% Si, 8.67% Al, 0.10% K, 5.23% Ca, 0.16% Mg, 0.80% Na, 0.43% Fe and 0.11% Ti, and a topology formed by two perpendicular channel systems of 10 members (in the direction [100], with a diameter of 0.50×0.47 nm) and 8 members (in the direction [001], with a diameter of 0.27×0.56 nm).

A second specific example of natural zeolite is a commercial clinoptilolite, featuring a composition by weight of 31.24% Si, 5.76% Al, 2.47% K, 1.82% Ca, 0.59% Mg, 0.48% Na, 0.83% Fe and 0.04% Ti.

A second object of the invention consists of the method for obtaining the material of the invention, comprising a controlled cationic interchange of the Ca²⁺ of the natural zeolite, and the subsequent precipitation of HAp on the surface of the zeolite in the presence of a source of phosphorus, in accordance with equations 1 to 3 (“ac.” signifies “in aqueous solution”):

(NH₄)₂HPO₄ (dis)→2NR₄⁺ (ac)+HPO₄²⁻ (ac) [eq. 1]

Zeo-Ca²⁺+2NH₄⁺ (ac) [symbol] Zeo-(NH₄⁺)₂+Ca²⁺ (ac) [eq. 2]

Zeo-(NH₄⁺)₂+5Ca²⁺ (ac)+3HPO₄²⁻ (ac)+4NH₃ (ac)+H₂O [symbol] Zeo-(NH₄⁺)₂ . . . Ca₅(PO₄)₃OH+4NH₄⁺ (ac) [eq. 3]

In one aspect of the invention, the method of the invention comprises the following steps:
a) grinding of the natural zeolite, sifting through sieves of 200 mesh and 125 mesh, and selection of the fraction with a particle size of less than 0.125 mm,
b) blending of the natural zeolite with a source of phosphorus in a proportion between 10 g (zeolite)/30 ml (solution) and 1 g (zeolite)/30 ml (solution) and stirring of the same for a period of between 5 and 15 minutes,
c) adjusting the pH of the mixture to values of between 8.5 and 10.0 inclusive, using an aqueous solution of NH₃ at 25%,
d) application of a thermal treatment at temperatures of between 15° C. and 170° C. inclusive, and during a period of between 0.5 and 120 hours inclusive,
e) separation of the solid from the solution by filtration and washing with distilled water, using a proportion of 1 litre of water to 2g of solid, and
f) drying of the solid.

“Synthesised mixture” is understood to be the product consisting of a mixture of ground, sieved natural zeolite, together with a source of phosphorus, whose pH has been adjusted by using an aqueous solution of NH₃ at 25%.

In one aspect of the invention, the temperature applied to the synthesised mixture during the thermal treatment in step d) is equal to, or higher than, 60° C.

In another aspect of the invention, the temperature applied to the synthesised mixture during the thermal treatment in step d) is lower than 60° C. and equal to, or higher than, 40° C.

In another aspect of the invention, the temperature applied to the synthesised mixture during the thermal treatment in step d) is lower than 40° C. and equal to, or higher than, 15° C.

In a preferred embodiment:
a) a natural stilbite zeolite from the mines of Ethiopia is ground in a disc mill, and is sieved to obtain particles of a size of between 0.074 and 0.125 mm,
b) the source of phosphorus is dibasic ammonium phosphate [(NH₄)₂HPO₄] at a concentration of 1M, blended at a proportion of 2 g (zeolite)/30 mL (solution), and stirred for 10 minutes in a polypropylene container,
c) adjustment of the pH of the medium for preparation of the composite material is performed at a value of 9.0, using an aqueous solution of NH₃ at 25%,
d) the application of the thermal treatment is performed during 19 hours at a temperature of 23° C.,
e) the separation of the solid from the solution is performed by vacuum filtration, and the washing with distilled water at a proportion of 1 litre of water for each 2 g of the solid obtained, and
f) the solid is air-dried.

In another preferred embodiment:
a) a natural stilbite zeolite from the mines of Ethiopia is ground in a disc mill, and is sieved to obtain particles of a size of between 0.074 and 0.125 mm,
b) the source of phosphorus is dibasic ammonium phosphate [(NH₄)₂HPO₄] at a concentration of 1M, blended at a proportion of 2 g (zeolite)/30 mL (solution), and stirred for 10 minutes in a polypropylene container,
c) adjustment of the pH of the medium for preparation of the composite material is performed at a value of 9.2, using an aqueous solution of NH₃ at 25%,
d) the application of the thermal treatment is performed during 6 hours at a temperature of 23° C.,
e) the separation of the solid from the solution is performed by vacuum filtration, and the washing with distilled water at a proportion of 1 litre of water for each 2 g of the solid obtained, and
f) the solid is air-dried.

In another preferred embodiment:
a) a natural commercial clinoptilolite zeolite is ground in a disc mill, and is sieved to obtain particles of a size of between 0.074 and 0.125 mm,
b) the source of phosphorus is dibasic ammonium phosphate [(NH₄)₂HPO₄] at a concentration of 1M, blended at a proportion of 2 g (zeolite)/30 mL (solution), and stirred for 10 minutes in a polypropylene container,
c) adjustment of the pH of the medium for preparation of the composite material is performed at a value of 9.02, using an aqueous solution of NH₃ at 25%,
d) the application of the thermal treatment is performed during 19 hours at a temperature of 23° C.,
e) the separation of the solid from the solution is performed by vacuum filtration, and the washing with distilled water at a proportion of 1 litre of water for each 2 g of the solid obtained, and
f) the solid is air-dried.

The third object of the present invention consists of the use of the material of the invention for removing fluoride from water.

In one aspect of the invention, the use of the material of the invention consists of the following stages:
i) preparation of the composite material in accordance with the procedure of the invention,
ii) contact with stirring between the material of the invention and water bearing an initial concentration of fluoride of between 4 and 20 mg/L, and a pH of between 6 and 8.5, at a proportion of between 2 and 50 g of material per litre of water to be treated, for a period of time of between 0.5 and 20 hours, and
iii) regeneration of the material of the invention by means of treatment with a solution of. NaOH at a pH of 11, stirred for a period of between 0.5 and 24 hours.

In a particular embodiment of the use of the material of the invention for removing fluoride in water, in stage ii), contact with stirring with the material of the invention is performed with waters comprising an initial concentration of fluoride of 10.8 mg/L and a pH of 8, at a proportion of 10 g of material per litre of water to be treated, during a period of 19 hours, and in stage iii), regeneration of the material of the invention, a solution of NaOH at a pH of 11 is used, stirred for a period of 3 hours (see examples 24 and 25).

### BRIEF DESCRIPTION OF THE DRAWINGS

FIG. 1 shows X-ray diffraction patterns of initial natural stilbite (STI) zeolite (black unbroken line), of stilbite interchanged with NH₄⁺ (grey unbroken line) (interchange conditions: 1 M solution of NH₄CI at 90° C. during 16 h) and of the composite material STI/HAp obtained with stilbite by crystallisation at 150° C. for 24 hours, in accordance with the procedure described in Example 2 (black dotted line). The black arrows indicate the diffractions assigned to hydroxyapatite.

FIG. 2 shows a ³¹P Magic-Angle Solid State Nuclear Magnetic Resonance of the composite material STI/HAp obtained with stilbite at 150° C. over 24 hours, in accordance with the procedure described in example 2 (black line) and at ambient temperature over 19 hours, in accordance with the procedure described in example 7 (grey line), and of the composite LTA/HAp obtained with zeolite A at ambient temperature over 8 hours, in accordance with the procedure described in example 11 (black dotted line).

FIG. 3 shows a mapping of the different elements (by EDX-TEM) and transmission electron microscope images of the composite material STI/HAp prepared with stilbite by crystallisation at ambient temperature over 19 hours, in accordance with the procedure described in example 7.

FIG. 4 shows the concentration of fluoride in equilibrium (in mg/L) with regard to the dose of adsorbent (of the entirety of the composite material, in g/L) (calculated according to equation 5) of the material obtained with stilbite at ambient temperature over 19 hours, in accordance with the procedure described in example 7. Defluorination conditions according to example 18: [F]ₒ=5 mg/L; Time=19 h; pH (autogenous)=7.5-8.5. The black dotted line indicates the limit of 1.5 mg/L established by the WHO.

FIG. 5 shows the intrinsic defluoridation capacity of hydroxyapatite (in mg of (F⁻)/g of HAp) (calculated according to equation 6) with regard to the dose of total adsorbent (including all the composite material, in g/L) (above) and with regard to the intrinsic dose of HAp (including only the quantity of HAp, in g/L) of the STI/HAp material obtained with stilbite at ambient temperature over 19 hours (example 7). Defluorination conditions as in example 18: [F]ₒ=5 mg/L; Time=19 h; pH (autogenous)=7.5-8.5.

FIG. 6 shows the concentration of fluoride in equilibrium (in mg/L) with regard to the intrinsic dose of HAp (including only the quantity of HAp, in g/L) of the composite material obtained from the stilbite (crystallised at ambient temperature over 19 hours, in accordance with the procedure described in example 7). Defluorination conditions as in example 18: [F]ₒ=5 mg/L; Time=19 h; pH (autogenous)=7.5-8.5. The black dotted line indicates the limit of 1.5 mg/L established by the WHO.

FIG. 7 shows a ³¹P Magic-Angle Solid State Nuclear Magnetic Resonance of the adsorbent material obtained at ambient temperature over 19 hours, in accordance with the procedure described in example 7, subsequent to the process of elimination of the fluoride. Defluorination conditions as in example 18: [F]ₒ=5 mg/L; Time=19 h; pH (autogenous)=7.5-8.5.

### EXAMPLES OF EMBODIMENTS

Different examples, illustrating the details of the preparation of different materials which are the object of the present patent, of the treatments for the elimination of fluoride from water by means of said materials and under different conditions, and of the regeneration of the materials are described below, without limiting the scope of the present invention.

### Example 1

### Characterisation of a Natural Stilbite Zeolite from Ethiopia

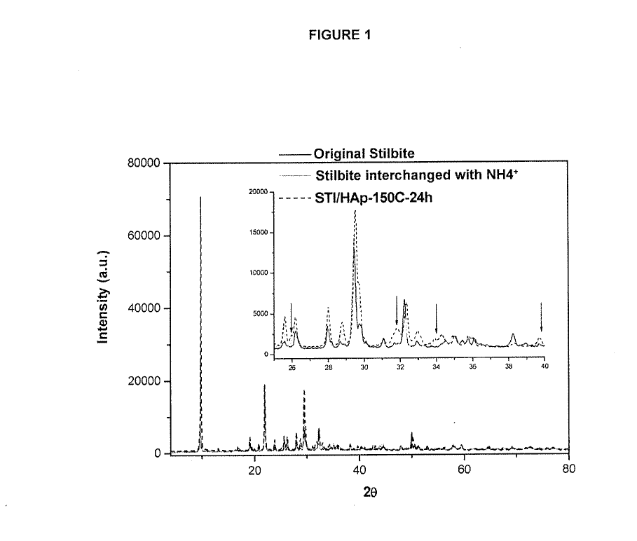

One of the natural zeolites employed was a stilbite (STI) mineral from Ethiopia, possessing the composition indicated in Table 1, where the high content of Ca²⁺ (5.23% by weight) should be noted. The molar composition of the unit cell of zeolite, including only the most abundant elements, and assuming that they are part of the STI zeolitic network, is (Na_{0.94} K_{0.06}) (Ca_{3.5} Mg_{0.18}) Al_{8.6} Si_{27.4} O₇₂. The X-ray diffractogram (FIG. 1, black line) indicates that it is stilbite mineral of high purity.

TABLE 1
Composition of natural stilbite zeolite (measured by ICP,
in % by weight) from Ethiopia, used as a source of Ca²⁺.

| Al | B | Ba | Ca | Mg | Fe | K | Li |
|---|---|---|---|---|---|---|---|
| 8.6690 | 0.8119 | 0.0025 | 5.2300 | 0.1565 | 0.4251 | 0.0952 | 0.5091 |
| Mn | Na | Nb | Si | Sr | Ti | V | Zr |
| 0.0110 | 0.7988 | 0.0113 | 29.5000 | 0.0034 | 0.1125 | 0.0005 | 0.0015 |

### Example 2

### Preparation of the Composite Material STI/HAp by Crystallisation at 150° C. Over 24 Hours

2.00 g of sieved ground stilbite zeolite (particle size between 0.074 and 0.125 mm) were added to 30 mL of a 1 M solution of (NH₄)₂HPO₄ and this was stirred (magnetic stirring) during 10 minutes. The pH was then measured, yielding a result of 8.00. An aqueous solution of NH₃ at 25% was then added, until a pH of 9.04 was reached. The magnetic stirrer was removed, and the mixture was placed in a glass liner, and this in a 100 mL autoclave.

The autoclave was placed in an oven at 150° C. at static heating for 24 hours. The resultant product was filtered and washed in abundant distilled water, obtaining 1.88 g of a white solid.

The materials obtained in examples 2 to 11 were analysed by X-ray diffraction (XRD), Phosphorus Magic-Angle Solid State Nuclear Magnetic Resonance (MAS-RMN), Transmission Electron Microscopy with an X-ray Dispersive Energy analyser (TEM-EDX) and Elemental Chemical Analysis by Inductive Coupling of Plasma (ICP). The HAp content (in percentage by weight) in the materials was calculated from the content of P obtained from the Elemental Analysis (% by weight of P (ICP)), following equation 4:

$$( \% weight {HA}_{p} ) = ( ( \% weight of P ( ICP ) ) \cdot \frac{502}{93} \qquad [ eq . 4 ]$$

where 502 is the total molecular weight of the HAp, and 93 is the molecular weight of the P in the HAp (Ca₅(PO₄)₃OH).

The diffractogram of the solids obtained (black dotted line) is presented in FIG. 1 together with that of the initial stilbite zeolite (black unbroken line), and the latter interchanged with NH₄⁺ (grey unbroken line). It may be clearly observed that the structure of the zeolite is conserved during the thermal treatment. Furthermore, additional peaks may be observed around 20 angles of 26, 32, 34 and 40 degrees, which are ascribed to the formation of HAp crystals, demonstrating the formation of these by means of the present preparation methodology.

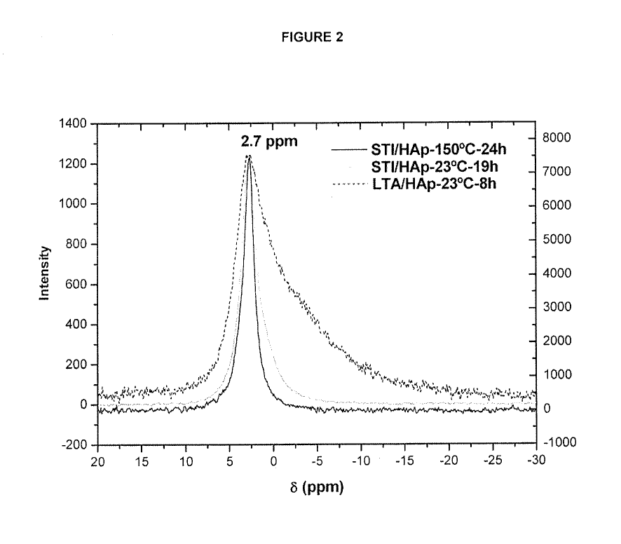

FIG. 2 shows the solid-state MAS-RMN spectrum of the ³¹P of this material (black line), where a symmetric signal is observed at 2.7 ppm; this being characteristic of the P in the HAp, demonstrating the formation of the same in the material.

### Example 3

### Preparation of the Composite Material STI/HAp by Crystallisation at 150° C. Over 6 Hours

2.00 g of sieved ground stilbite zeolite (particle size between 0.074 and 0.125 mm) were added to 30 mL of a 1 M solution of (NH₄)₂HPO₄ and this was stirred (magnetic stirring) during 10 minutes. The pH was then measured, yielding a result of 8.05. An aqueous solution of NH₃ at 25% was then added, until a pH of 9.02 was reached. The magnetic stirrer was removed, and the mixture was placed in a glass liner, and this in a 100 mL autoclave. The autoclave was placed in an oven at 150° C. at static heating for 6 hours. The resultant product was filtered and washed in abundant distilled water, obtaining 1.90 g of a white solid.

The X-ray diffractogram demonstrates the resistance of the zeolitic structure to the HAp crystallisation process. However, it is not possible to observe clearly the peaks associated with the HAp, possibly due to its lower concentration in the solid and its overlapping with the diffractions of the zeolite.

### Example 4

### Preparation of the Composite Material STI/HAp by Crystallisation at 60° C. Over 2 Hours

2.00 g of sieved ground stilbite zeolite (particle size between 0.074 and 0.125 mm) were added to 30 mL of a 1 M solution of (NH₄)₂HPO₄ and this was stirred (magnetic stirring) during 10 minutes. The pH was then measured, yielding a value of 7.92. NH₃ at 25% was then added, until a pH of 9.01 was reached. The magnetic stirrer was removed, and the mixture was placed in a glass liner, and this in a 100 mL autoclave.

The autoclave was placed in an oven at 60° C. at static heating for 2 hours.

The resultant product was filtered and washed in abundant distilled water, obtaining 1.92 g of a white solid.

The X-ray diffractogram demonstrates the resistance of the zeolitic structure to the HAp crystallisation process. However, it is not possible to observe clearly the peaks associated with the HAp, possibly due to its lower concentration in the solid and its overlapping with the diffractions of the zeolite.

### Example 5

### Preparation of the Composite Material STI/HAp by Crystallisation at 60° C. Over 6 Hours

2.00 g of sieved ground stilbite zeolite (particle size between 0.074 and 0.125 mm) were added to 30 mL of a 1 M solution of (NH₄)₂HPO₄ and this was stirred (magnetic stirring) during 10 minutes. The pH was then measured, yielding a value of 7.93. An aqueous solution of NH₃ at 25% was then added, until a pH of 9.00 was reached. The magnetic stirrer was removed, and the mixture was placed in a glass liner, and this in a 100 mL autoclave.

The autoclave was placed in an oven at 60° C. at static heating for 6 hours. The resultant product was filtered and washed in abundant distilled water, obtaining 1.94 g of a white solid.

The X-ray diffractogram demonstrates the resistance of the zeolitic structure to the HAp crystallisation process. However, it is not possible to observe clearly the peaks associated with the HAp, possibly due to its lower concentration in the solid and its overlapping with the diffractions of the zeolite.

### Example 6

### Preparation of the Composite Material STI/HAp by Crystallisation at Ambient Temperature (23° C.) Over 6 Hours

2.00 g of sieved ground stilbite zeolite (particle size between 0.074 and 0.125 mm) were added to 30 mL of a 1 M solution of (NH₄)₂HPO₄ and this was stirred (magnetic stirring) during 10 minutes. The pH was then measured, yielding a value of 8.02. An aqueous solution of NH₃ at 25% was then added, until a pH of 9.02 was reached. The magnetic stirrer was removed.

The polypropylene container was placed in a bath of water, thermostatically controlled at ambient temperature, at static heating for 6 hours. The resultant product was filtered and washed in abundant distilled water, obtaining 1.90 g of a white solid.

The X-ray diffractogram demonstrates the resistance of the zeolitic structure to the HAp crystallisation process. However, it is not possible to observe clearly the peaks associated with the HAp, possibly due to its lower concentration in the solid and its overlapping with the diffractions of the zeolite.

### Example 7

### Preparation of the Composite Material STI/HAp by Crystallisation at Ambient Temperature (23° C.) Over 19 Hours

2.00 g of sieved ground stilbite zeolite (particle size between 0.074 and 0.125 mm) were added to 30 mL of a 1 M solution of (NH₄)₂HPO₄ and this was stirred (magnetic stirring) during 10 minutes. The pH was then measured, yielding a value of 8.03. An aqueous solution of NH₃ at 25% was then added, until a pH of 9.02 was reached. The magnetic stirrer was removed.

The polypropylene container was placed in a bath of water, thermostatically controlled at ambient temperature, at static heating for 19 hours. The resultant product was filtered and washed in abundant distilled water, obtaining 1.96 g of a white solid.

The X-ray diffractograms of this material once again confirm the resistance of the zeolitic structure to the treatment. However, it is not possible to observe clearly the peaks associated with the HAp, possibly due to its lower concentration in the solid and its overlapping with the diffractions of the zeolite.

FIG. 2 shows the solid-state MAS-RMN spectrum of the ³¹P of this material (grey line). The same signal as in example 2 (obtained at 150° C., black line) is observed at 2.7 ppm; this being characteristic of the P in the HAp, demonstrating the formation of the same in the material. However, in this case a greater band width (compared with the material prepared in example 2) is observed, as is a shoulder at around 0 ppm; both of these characteristics are associated with the nanometric nature of the HAp [C. Jäger, W. Meyer-Zaika and M. Epple, Magnetic Resonance in Chemistry, 44 (2006) 573-580], which suggests a smaller HAp particle size obtained at lower temperatures.

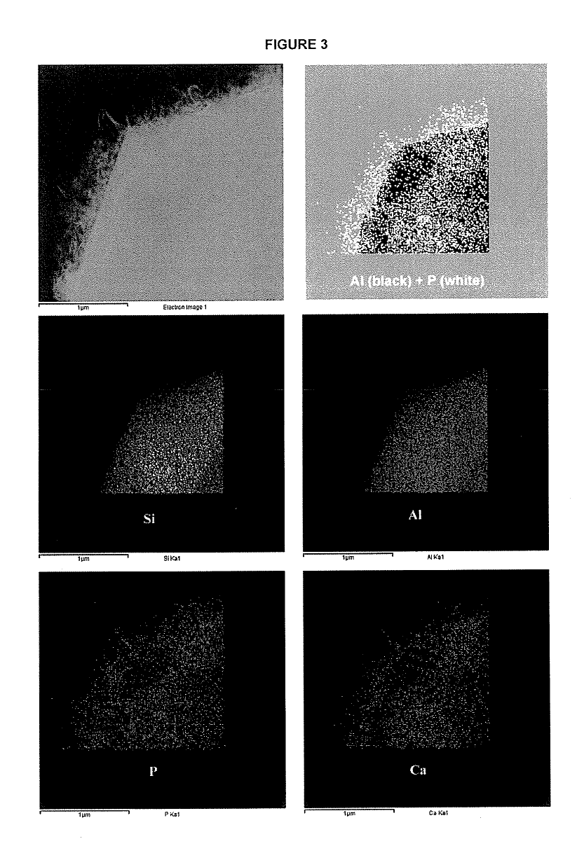

FIG. 3 presents a transmission electron microscope image (above left) and an EDX mapping by elements of the same area. This figure clearly shows the crystallisation of the HAp, whose unmistakeably distinguishable element is the P (below left) adhering to the surface of the stilbite zeolite crystals, whose distinguishable elements are Si and Al (centre, left and right respectively). Conversely, the Ca²⁺ may originate from the stilbite which has not been interchanged, or from the HAp (bottom right).

### Example 8

### Preparation of the Composite Material STI/HAp by Crystallisation at Ambient Temperature (23° C.) Over 19 Hours, using a Concentration of 0.5 M of (NH₄)₂HPO₄

2.00 g of sieved ground stilbite zeolite (particle size between 0.074 and 0.125 mm) were added to 30 mL of a 0.5 M solution of (NH₄)₂HPO₄ and this was stirred (magnetic stirring) during 10 minutes. The pH was then measured, yielding a value of 8.01. An aqueous solution of NH₃ at 25% was then added, until a pH of 9.00 was reached. The magnetic stirrer was removed.

The polypropylene container was placed in a bath of water, thermostatically controlled at ambient temperature, at static heating for 19 hours. The resultant product was filtered and washed in abundant distilled water, obtaining 1.87 g of a white solid.

The X-ray diffractogram demonstrates the resistance of the zeolitic structure to the HAp crystallisation process. However, it is not possible to observe clearly the peaks associated with the HAp, possibly due to its lower concentration in the solid and its overlapping with the diffractions of the zeolite.

### Example 9

### Preparation of the Composite Material STI/HAp by Crystallisation at Ambient Temperature (23° C.) Over 19 Hours, using a Synthesis pH of 9.5

2.00 g of sieved ground stilbite zeolite (particle size between 0.074 and 0.125 mm) were added to 30 mL of a 1 M solution of (NH₄)₂HPO₄ and this was stirred (magnetic stirring) during 10 minutes. The pH was then measured, yielding a value of 8.07. An aqueous solution of NH₃ at 25% was then added, until a pH of 9.50 was reached. The magnetic stirrer was removed.

The polypropylene container was placed in a bath of water, thermostatically controlled at ambient temperature, at static heating for 19 hours. The resultant product was filtered and washed in abundant distilled water, obtaining 1.98 g of a white solid.

The X-ray diffractogram demonstrates the resistance of the zeolitic structure to the HAp crystallisation process. However, it is not possible to observe clearly the peaks associated with the HAp, possibly due to its lower concentration in the solid and its overlapping with the diffractions of the zeolite.

### Example 10

### Preparation of the Composite Material CLI/HAp by Crystallisation at Ambient Temperature (23° C.) Over 19 Hours

2.00 g of sieved ground clinoptilolite zeolite (particle size between 0.074 and 0.125 mm) were added to 30 mL of a 1 M solution of (NR₄)₂HPO₄ and this was stirred (magnetic stirring) during 10 minutes. The pH was then measured, yielding a value of 8.18. An aqueous solution of NH₃ at 25% was then added, until a pH of 9.02 was reached. The magnetic stirrer was removed.

The polypropylene container was placed in a bath of water, thermostatically controlled at ambient temperature, at static heating for 19 hours. The resultant product was filtered and washed in abundant distilled water, obtaining 1.88 g of a white solid.

### Example 11

### Preparation of the Composite Material LTA/HAp by Crystallisation at Ambient Temperature (23° C.) Over 8 Hours

A material was prepared from synthetic zeolite A, following the procedure reported in the literature (Y. Wanatabe, T. Ikoma, Y. Suetsugu, H. Yamada, K. Tamura, Y. Komatsu, J. Tanaka, Y. Moriyoshi, J. Eur. Cer. Soc. 26 (2006) 469-474). Initially the zeolite A was interchanged with Ca cations. 5.00 g of commercial zeolite A in sodium form were added to 1.5 L of CaCl₂ (Panreac) solution at 0.5 M, and this was stirred magnetically during 24 hours at ambient temperature. The solid was then filtered and washed in abundant distilled water.

0.6 g of zeolite A interchanged with Ca²⁺ was added to 40 mL of a 1 M solution of (NH₄)₂HPO₄ and this was stirred (magnetic stirring) during 10 minutes. The pH was then measured, yielding a value of 8.13. An aqueous solution of NH₃ at 25% was then added, until a pH of 8.99 was reached. The magnetic stirrer was removed.

The polypropylene container was placed in a bath of water, thermostatically controlled at ambient temperature, at static heating for 19 hours. The resultant product was filtered and washed in abundant distilled water, obtaining 0.57 g of a white solid.

The X-ray diffractograms demonstrate the resistance of the zeolitic structure (LTA) to treatment. However, it is not possible to observe clearly the peaks associated with the HAp, possibly due to its lower concentration in the solid and its overlapping with the diffractions of the zeolite. FIG. 2 shows the solid-state MAS-RMN spectrum of the ³¹P of this material (black dotted line), which is notably different from that of the material of the invention. A wide, asymmetric signal may be observed centred at 2.7 ppm, a characteristic of the P in the HAp, demonstrating the formation of the same in the material. However, in this case, a wide band may be observed between 0 and −20 ppm, this being characteristic of P in other environments, with different degrees of condensation. These results indicate that the composite material prepared with zeolite A is significantly different from that of the present invention prepared with stilbite.

### Example 12

### Fluoride Removal Treatment with the Material from Example 2, at a Dose of 50 g/L and with an Initial Fluoride Concentration of 4.3 mg/L

In general, for examples 12 to 25, the solutions with known concentrations of fluoride were prepared from a standard solution of NaF 0.1 M per dilution. This last was prepared by weighing on an analytical scale (subsequent to drying at 100° C. overnight) the corresponding amount of NaF (Aldrich, analytical grade) and adding a specific volume of water (miliQ).

The initial concentration and that of equilibrium (subsequent to the elimination process) of the fluoride were determined with a fluoride-selective ion electrode, (CRYSON pH & Ion meter GLP 22 equipment). This same equipment was used to measure the initial pH and that of the solution equilibrium.

Two types of fluoride removal capacity are defined. The total capacity of the adsorbent (Cₜₒₜₐₗ) refers to the total mass of the composite material, including the zeolite and the HAp, and is calculated by following equation 5. The intrinsic capacity of the HAp (C_{HAp}) refers only to the percentage of HAp in the composite material, and is calculated by following equation 6.

$$\begin{matrix}Ctotal = \frac{[ F ] o - [ F ] f}{Total dose } & [ eq . 5 ] \\ CHAp = \frac{[ F ] o - [ F ] f}{Total dose \cdot \frac{( \% weight HAp )}{100}} & [ eq . 6 ]\end{matrix}$$

where [F]ₒ and [F]_{f} refer to the initial concentration of fluoride and that subsequent to the elimination treatment, respectively, given in mg/L. The total dose refers to the total mass of the adsorbent (composite material, zeolite+HAp) by volume of solution to be treated, given in g/L; and (% weight HAp) refers to the percentage by weight of HAp in the composite material, calculated according to equation 4. Both capacities are given in mg of F⁻/g (of total adsorbent or of HAp).

1.00 g of the material obtained in accordance with example 2 was added to 20 mL of F⁻ solution at a known concentration of 4.3 mg/L in a 100 mL polypropylene container. The mixture was maintained under magnetic stirring during 19 hours, subsequent to which it was filtered and the concentration of F of the resulting solution in equilibrium was measured.

Thus, a final concentration of fluoride of 0.5 mg/L in equilibrium was observed, which corresponds to a percentage of elimination of 89.4%, a capacity of total elimination of 0.08 mg(F⁻)/g(adsorbent), and an intrinsic removal capacity of the apatite of 0.66 mg(F⁻)/g(HAp), in the region of, although slightly lower than, the values reported in the literature for other hydroxyapatites. This example shows that the HAp prepared by means of this procedure is able to reduce the concentration of fluoride to well below the limit established by the WHO (1.5 mg/L).

### Example 13

### Fluoride Removal Treatment with the Material from Example 3, at Doses of 25 and 50 g/L and with an Initial Fluoride Concentration of 4.3 mg/L

0.50 or 1.00 g (to obtain doses of 25 and 50 g/L, respectively) of the material obtained in accordance with example 3 was added to 20 mL of F⁻ solution at a known concentration of 4.3 mg/L in a 100 mL polypropylene container. The mixture was maintained under magnetic stirring during 19 hours, subsequent to which it was filtered and the concentration of F⁻ of the resulting solution in equilibrium was measured.

The final concentration of fluoride in equilibrium was 1.3 and 0.5 mg/L for doses of 25 and 50 g/L, respectively, which corresponds to a percentage of elimination of 70.0 and 89.0%, a capacity of total elimination of 0.12 and 0.08 mg(F⁻)/g(adsorbent), and intrinsic removal capacities of the apatite of 0.94 and 0.60 mg(F⁻)/g(HAp), respectively. This example shows clearly that the removal capacity increases as the dose of adsorbent is reduced, a behaviour widely observed in prior studies reported. A reduction to half the dose (25 g/L) of this material still entails compliance with the WHO's concentration limit.

### Example 14

### Fluoride Removal Treatment with the Material from Example 4, at a Dose of 25 g/L and with an Initial Fluoride Concentration of 4.3 mg/L

0.50 g of the material obtained in accordance with example 4 was added to 20 mL of F solution at a known concentration of 4.3 mg/L in a 100 mL polypropylene container. The mixture was maintained under magnetic stirring during 19 hours, subsequent to which it was filtered and the concentration of F of the resulting solution in equilibrium was measured.

The concentration of fluoride in equilibrium subsequent to the elimination process was 0.2 mg/L, which corresponds to a removal capacity of 94.3%, a capacity of total elimination of 0.16 mg(F⁻)/g(adsorbent), and an intrinsic removal capacity of the apatite of 3.28 mg(F⁻)/g(HAp), greater than the majority of the hydroxyapatites reported in the literature. This example shows that the HAp prepared at lower crystallisation temperatures has a significantly greater fluoride elimination capacity than those prepared at higher temperatures.

### Example 15

### Fluoride Removal Treatment with the Material from Example 5, at a Dose of 25 g/L and with an Initial Fluoride Concentration of 4.3 mg/L

0.50 g of the material obtained in accordance with example 5 was added to 20 mL of F⁻ solution at a known concentration of 4.3 mg/L in a 100 mL polypropylene container. The mixture was maintained under magnetic stirring during 19 hours, subsequent to which it was filtered and the concentration of F⁻ of the resulting solution in equilibrium was measured.

The concentration of fluoride in equilibrium subsequent to the elimination process was 0.5 mg/L, which corresponds to a removal capacity of 88.1%, a capacity of total elimination of 0.15 mg(F⁻)/g(adsorbent), and an intrinsic elimination capacity of the apatite of 2.16 mg(F⁻)/g(HAp). These results, compared with those of example 14, indicate that the longer HAp crystallisation times entail a reduction in its intrinsic capacity to remove fluoride, possibly due to a secondary growth of the crystals and therefore a lesser proportion of external (efficient) area in comparison with the internal (inert) area. Therefore, this example, together with the previous ones, seems to indicate that lower crystallisation temperatures and shorter times give rise to a HAp which is notably more efficient for the elimination of fluoride.

### Example 16

### Fluoride Elimination Treatment with the Material from Example 6, at Doses of 10 and 25 g/L and with an Initial Fluoride Concentration of 5.0 or 4.3 mg/L

0.50 g (for a dose of 25 g/L) of the material obtained in accordance with example 6 was added to 20 mL of F⁻ solution at a known concentration of 4.3 mg/L in a 100 mL polypropylene container. The mixture was maintained under magnetic stirring during 19 hours, subsequent to which it was filtered and the concentration of F of the resulting solution in equilibrium was measured.

The concentration of fluoride in equilibrium subsequent to the elimination process with this dose of 25 g/L was 0.1 mg/L, which corresponds to a removal capacity of 98.2%, a capacity of total elimination of 0.17 mg(F⁻)/g(adsorbent), and an intrinsic removal capacity of the apatite of 4.64 mg(F⁻)/g(HAp), once again showing a clear improvement in the capacity of the HAp on reducing the crystallisation temperature to 23° C.

The same material, at a lower dose of 10mg/L, was then assayed, adding 0.20 g of adsorbent (instead of 0.50 g) to 20 mL of a solution at 5.0 mg/L (pH=8.23). Subsequent to the elimination process, a concentration of fluoride of 1.6 mg/L was observed, which corresponds to a removal capacity of 67.5%, a capacity of total elimination of 0.34 mg(F⁻)/g(adsorbent), and an intrinsic elimination capacity of the apatite of 9.19 mg(F⁻)/g(HAp), notably higher than those reported in the literature for diluted solutions of fluoride (between 5 and 10 mg/L).

### Example 17

### Fluoride Removal Treatment with the Material from Example 6, at a Dose of 10 g/L and with an Initial Fluoride Concentration of 5.0 mg/L, and an Initial pH Adjusted to 6.06

0.20 g of the material obtained in accordance with example 6 was added to 20 mL of F⁻ solution at a known concentration of 5.0 mg/L in a 100 mL polypropylene container. HCl at 0.05 M was then added until a final pH of 6.06 was reached. The mixture was maintained under magnetic stirring during 19 hours, subsequent to which it was filtered and the concentration of F⁻ of the resulting solution in equilibrium was measured.

The concentration of fluoride in equilibrium subsequent to the elimination process was 0.8 mg/L, which corresponds to a removal capacity of 83.8%, a capacity of total elimination of 0.42 mg(F⁻)/g(adsorbent), and an intrinsic removal capacity of the apatite of 11.40 mg(F⁻)/g(HAp). On comparing this result with that of example 16 at the same dose (10 g/L), it may be clearly observed that a reduction of the pH from 8.23 (autogenous pH) to 6.06 entails a clear improvement in the intrinsic removal capacity of the HAp, increasing from 9.19 to 11.40 mg(F⁻)/g(HAp) respectively. This pH-related behaviour has been widely observed in the literature. However, it should be noted that the pH of waters in the subsoil is generally in the region of 8, where many adsorbents are not effective, although the results of the present invention indicate that these composite materials are effective.

### Example 18

### Fluoride Removal Treatment with the Material from Example 7, at Different Doses and with an Initial Fluoride Concentration of 5.0 mg/L

Variable quantities (0.0403 g, 0.0801 g, 0.1195 g, 0.1595 g, 0.1998 g) of the material obtained in accordance with example 7 were added to 20 mL of F⁻ solution at a known concentration of 5.0 mg/L (for doses of 2, 4, 6, 8 and 10 g/L, respectively) in a 100 mL polypropylene container. The mixtures were maintained under magnetic stirring during 19 hours, subsequent to which they were filtered and the concentrations of F⁻ of the resulting solutions in equilibrium were measured.

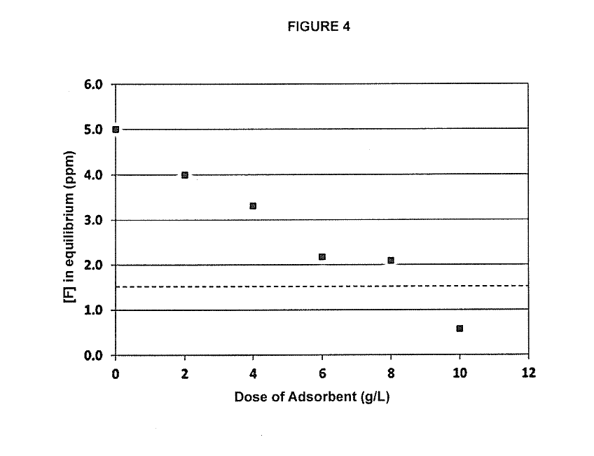

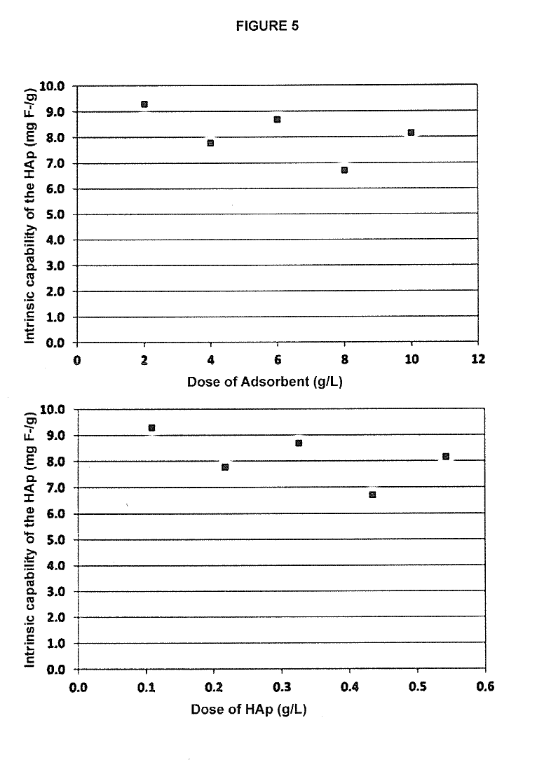

FIG. 4 shows the final concentration of F⁻ according to the total dose of adsorbent, where it may be seen that the final concentration of F⁻ falls almost linearly as the dose of adsorbent is increased. The limit of 1.5 mg/L is surpassed for total doses of adsorbent of between 8 and 10 g/L. FIG. 5 shows the relationship between the intrinsic capacity of the HAp in this material, calculated according to equation 6, in accordance with the total dose of adsorbent (above) or with the dose of HAp (below). Notably high intrinsic capacity values of HAp are observed, between 7 and 9 mg(F⁻)/g(HAp). Surprisingly, only a slight reduction in the intrinsic capacity of the HAp was observed on increasing the dose, varying between 9 and 7 mg(F⁻)/g(HAp), corresponding to a maximum reduction of around 20%; this behaviour is peculiar and characteristic of HAp obtained by this method. Conversely, in the HAp reported in the literature, a much more drastic reduction in the removal capacity is observed on increasing the dose of adsorbent; for example, the nanohydroxyapatite in (S. Gao, J. Cui, Z. Wei, J. Fluorine Chem. 130 (2009) 1035-104) reduces its capacity from ˜3 mg(F)/g (for HAp doses of less than 0.1 g/L) to ˜0.5 mg/g (for doses around 0.6 g/L), corresponding to a reduction of over 80% (similar behaviour is repeated in the majority of the HAp reported in the literature). Under similar HAp dose conditions (FIG. 5, below), the HAp obtained in accordance with example 7 drops from 9.30 mg/g (intrinsic HAp dose of 0.11 g/L) to 8.16 mg/g (intrinsic HAp dose of 0.54 g/L, corresponding to a 12% reduction.

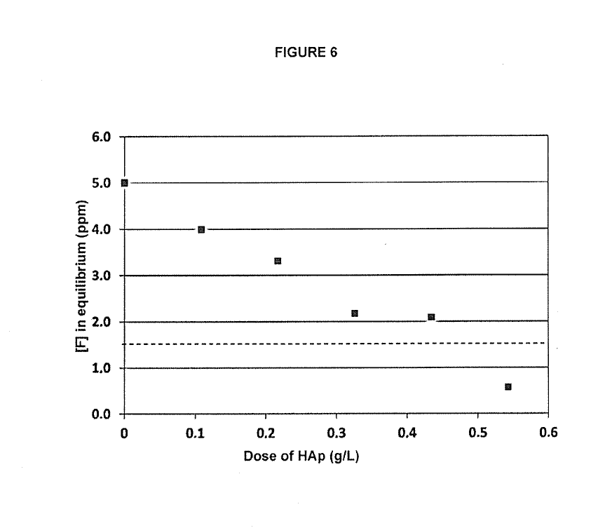

Finally, FIG. 6 shows the fluoride concentration in equilibrium compared with the intrinsic HAp dose, where it may be observed that an intrinsic HAp dose of around 0.5 g/L is sufficient to reduce the fluoride concentration from 5.0 mg/L to below the limit stipulated by the WHO.

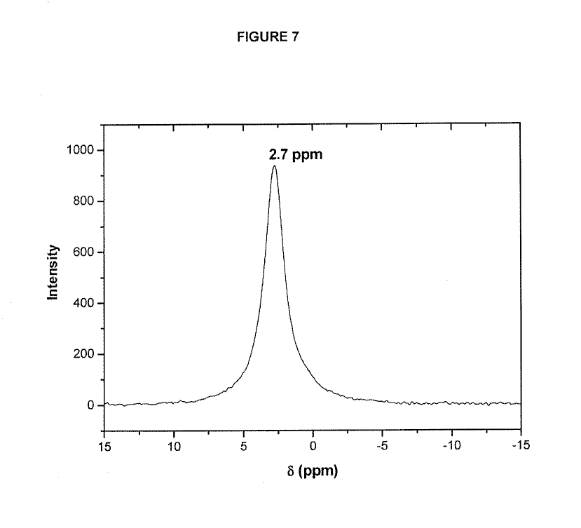

Finally, the RMN ³¹P spectrum of the material subsequent to the elimination of the (10 g/L dose) (FIG. 7) presents the same resonance as the original material at 2.7 ppm, demonstrating that the HAp resists the defluorination treatment.

### Example 19

### Fluoride Removal Treatment with the Material from Example 8, at a Dose of 10 g/L and with an Initial Fluoride Concentration of 5.0 mg/L

0.20 g of the material obtained in accordance with example 8 are added to 20 mL of F⁻ solution at a known concentration of 5.0 mg/L in a 100 mL polypropylene container. The mixture was maintained under magnetic stirring during 19 hours, subsequent to which it was filtered and the concentration of F⁻ of the resulting solution in equilibrium was measured.

The concentration of fluoride in equilibrium subsequent to the elimination process was 1.6 mg/L, which corresponds to a removal capacity of 68.7%, a capacity of total elimination of 0.35 mg(F⁻)/g(adsorbent), and an intrinsic removal capacity of the apatite of 8.82 mg(F⁻)/g(HAp). This result shows that the use of lower concentrations of dibasic ammonium diphosphate for the preparation of the adsorbent also gives rise to very high-capacity materials, which may involve clear economic advantages for the implementation of a defluorination process based on these materials.

### Example 20

### Fluoride Removal Treatment with the Material from Example 9, at a Dose of 10 g/L and with an Initial Fluoride Concentration of 5.0 mg/L

0.20 g of the material obtained in accordance with example 9 were added to 20 mL of F solution at a known concentration of 5.0 mg/L in a 100 mL polypropylene container. The mixture was maintained under magnetic stirring during 19 hours, subsequent to which it was filtered and the concentration of F⁻ of the resulting solution in equilibrium was measured.

The concentration of fluoride in equilibrium subsequent to the elimination process was 1.9 mg/L, which corresponds to a removal capacity of 63.0%, a capacity of total elimination of 0.32 mg(F⁻)/g(adsorbent), and an intrinsic removal capacity of the apatite of 11.54 mg(F⁻)/g(HAp). In this case, the increase in pH entails a lesser crystallisation of HAp, which in turn implies a lesser capacity of total elimination, but a greater intrinsic capacity of the HAp.

### Example 21

### Fluoride Removal Treatment with the Material from Example

10, at a Dose of 10 g/L and with an Initial Fluoride Concentration of 10.8 mg/L 0.20 g of the material obtained in accordance with example 10 were added to 20 mL of F⁻ solution at a known concentration of 10.8 mg/L in a 100 mL polypropylene container. The mixture was maintained under magnetic stirring during 19 hours, subsequent to which it was filtered and the concentration of F⁻ of the resulting solution in equilibrium was measured.

The concentration of fluoride in equilibrium subsequent to the elimination process was 7.5 mg/L, which corresponds to a removal percentage of 30.6%, a capacity of total elimination of 0.32 mg(F⁻)/g(adsorbent), and an intrinsic removal capacity of the apatite of 12.40 mg(F⁻)/g(HAp). This example shows that HAp prepared from Clinoptilolite is also capable of efficiently reducing the concentration of fluoride.

### Example 22

### Fluoride Removal Treatment with the Material from Example 10, at a Dose of 10 g/L and with an Initial Fluoride Concentration of 4.6 mg/L.

0.20 g of the material obtained in accordance with example 10 were added to 20 mL of F⁻ solution at a known concentration of 4.6 mg/L in a 100 mL polypropylene container. The mixture was maintained under magnetic stirring during 19 hours, subsequent to which it was filtered and the concentration of F⁻ of the resulting solution in equilibrium was measured.

The concentration of fluoride in equilibrium subsequent to the elimination process was 2.8 mg/L, which corresponds to a removal capacity of 39.1%, a capacity of total elimination of 0.18 mg(F⁻)/g(adsorbent), and an intrinsic removal capacity of the apatite of 7.0 mg(F⁻)/g(HAp). This example shows that HAp prepared from Clinoptilolite is also capable of eliminating fluoride, even at very low concentrations, yielding an intrinsic capacity of apatite similar to that of stilbite.

### Example 23

### Fluoride Removal Treatment with the Material from Example 11, at a Dose of 10 g/L and with an Initial Fluoride Concentration of 5.0 mg/L

For comparative purposes, the F− removal capacity of the material obtained using zeolite A as in the literature was analysed. 0.20 g of the material obtained in accordance with example 11 were added to 20 mL of F⁻ solution at a known concentration of 5.0 mg/L in a 100 mL polypropylene container. The mixture was maintained under magnetic stirring during 19 hours, subsequent to which it was filtered and the concentration of of the resulting solution in equilibrium was measured.

The concentration at equilibrium of fluoride subsequent to the elimination process was 0.5 mg/L, which corresponds to a removal percentage of 90.9%, a capacity of total elimination of 0.46 mg(F⁻)/g(adsorbent); however, the intrinsic removal capacity of the resulting apatite was 2.61 mg(F⁻)/g(HAp) (assuming that all the P pertains to the HAp), notably less than that of the HAp of the present invention obtained by using stilbite. This example highlights the intrinsic difference existing between the HAp obtained from synthetic zeolite A and that obtained by the procedures described in the present invention using natural zeolites.

### Example 24

### Fluoride Removal Treatment with the Material from Example 6, at a Dose of 10 g/L and with an Initial Fluoride Concentration of 10.8 mg/L, and Analysis of the Possibility of its Re-Use

0.70 g of the material obtained in accordance with example 6 were added to 70 mL of F⁻ solution at a known concentration of 10.8 mg/L and a pH of 8 in a 125 mL polypropylene container. The mixture was maintained under magnetic stirring during 19 hours, subsequent to which it was filtered and the concentration of F⁻ of the resulting solution in equilibrium was measured.

The concentration at equilibrium of fluoride subsequent to the elimination process was 6.9 mg/L, which corresponds to a removal percentage of 36.0%, a capacity of total elimination of 0.39 mg(F⁻)/g(adsorbent), and an intrinsic removal capacity of the apatite of 10.48 mg(F⁻)/g(HAp). On comparing this result with that of example 16 at the same dose (10 g/L) but with a lower initial concentration of fluoride (5.0 mg/L), an increase in the total fluoride removal capacity (0.39 mg(F⁻)/L) was observed at an initial concentration of 10.8 mg/L compared with 0.34 mg(F⁻)/L at an initial concentration of 5.0 mg/L, and consequently a greater intrinsic capacity of the HAp (10.48 mg(F⁻)/L compared with 9.19 mg(F⁻)/L, respectively, suggesting a behaviour frequently observed in adsorbent materials on increasing the initial fluoride concentration in the water to be treated. This example illustrates the greater difficulty to remove the fluoride from the water when the concentration of the same is reduced.

Next, the possibility of re-using these adsorbents once subjected to the defluorination treatment was studied. To this end, the material loaded with fluoride obtained beforehand was subjected to a new process for the elimination of the fluoride, under the same conditions. 0.67 g of the above material was added to 67 mL of F⁻ solution at a known concentration of 10.8 mg/L in a 125 mL polypropylene container. The mixture was maintained under magnetic stirring during 19 hours, subsequent to which it was filtered and the concentration of F⁻ of the resulting solution in equilibrium was measured.

The concentration in equilibrium of fluoride subsequent to the elimination process was 10.1 mg/L, which corresponds to a removal percentage of 5.8%, a capacity of total elimination of 0.06 mg(F⁻)/g(adsorbent), and an intrinsic removal capacity of the apatite of 1.69 mg(F⁻)/g(HAp). These results show that the capacity of removal of fluoride is practically exhausted with the first treatment, although it does maintain a certain non-negligible residual capacity. The sum of the elimination in the first and second treatments gives a total removal capacity of 0.45 mg(F⁻)/g(adsorbent) and an intrinsic capacity of the

HAp of 12.17 mg(F⁻)/g(HAp).

### Example 25

### Regeneration Treatment of the Material Used in Example 24

This example illustrates the possibility of regeneration of these adsorbents subsequent to their use in the fluoride elimination treatment. The material whose regeneration was studied was that obtained in example 24, subjected to two successive fluoride elimination treatments in order to guarantee the total exhaustion of its removal capacity.

0.30 g of the material obtained in accordance with example 24 was added to 30 mL of NaOH solution with a pH of 11; the pH of this initial mixture drops to 10.70 when the solid is added. The mixture was maintained under magnetic stirring during 3 hours, subsequent to which it was filtered and the solid and the resulting solution (solution 1) were collected. The solid (solid A) was washed with abundant water until the water used in the washing yielded a neutral pH.

The solution resulting from the regeneration process (solution 1) had a pH of 9.38, compared with its initial value of 11, which demonstrates the reduction in concentration of hydroxide, possibly due to the interchange of fluoride by hydroxide during the process. This solution had a concentration of fluoride of 1.4 mg mg/L, which suggests a desorption of 30% of the total quantity of fluoride in the sample subsequent to the two consecutive elimination treatments described in example 24. This example shows that the fluoride of the adsorbent may be easily desorbed by treatment with an alkaline aqueous solution. In all cases, this is merely an example of the possibility of desorption, but the desorption process is subject to improvement.

Finally, the regenerated adsorbent material (solid A) was subjected to a new process of elimination of fluoride. 0.19 g of solid A was added to 19 mL of F⁻ of a known concentration of 10.8 mg/L in a 50 mL polypropylene container. The mixture was maintained under magnetic stirring during 19 hours, subsequent to which it was filtered and the concentration of F⁻ of the resulting solution in equilibrium was measured.

The concentration of fluoride in equilibrium subsequent to the new process of elimination with the regenerated material was 9.8 mg/L, corresponding to an removal capacity of 10.0%, a capacity of total elimination of 0.10 mg(F⁻)/g(adsorbent), and an intrinsic removal capacity of the apatite of 2.62 mg(F⁻)/g(HAp). On comparing these values with the initial removal capacity of the same material (example 24), it may be observed that the regeneration capacity was approximately 25%, a value very similar to the desorption percentage obtained beforehand. This example illustrates the possibility of recycling these adsorbent materials. In all cases, as has been mentioned above, this is a single example, but the desorption process is subject to improvement.

1. A composite material of natural zeolite-nanohydroxyapatite, comprising:
a natural zeolite with an interchangeable calcium content of between 0.25 and 13% by weight, and possessing at least one system of channels whose smallest diameter is less than 0.41 nm; and
HAp crystals with a total percentage of interchangeable hydroxides of at least 10%.

2. The composite material according to claim 1, wherein the natural zeolite is a natural stilbite zeolite that possesses a Ca²⁺ content of 5.23% by weight.

3. The composite material according to claim 1, wherein the natural zeolite is a natural clinoptilolite zeolite, thatpossesses a Ca²⁺ content of 1.82% by weight.

4. A method for obtaining the composite material according to claim 1, wherein the growth of hydroxyapatite crystals on the natural zeolite is achieved by means of the controlled cationic interchange of the Ca²⁺ of the zeolite, and the subsequent precipitation of HAp on the surface of the zeolite in the presence of a source of phosphorus on the surface of the zeolite, in accordance with equations 1 to 3:
(NH₄)₂HPO₄ (dis)→2NH₄⁺ (ac)+HPO₄²⁻ (ac) [eq. 1]
Zeo-Ca²⁺+2NH₄⁺ (ac) [symbol] Zeo-(NH₄⁺)_{2 +}Ca²⁺ (ac) [eq. 2]
Zeo-(NH₄⁺)₂+5Ca²⁺ (ac)+3HPO₄²⁻ (ac)+4NH₃ (ac)+H₂O [symbol] Zeo-(NH₄⁺)₂ . . . Ca₅(PO₄)₃OH+4NH₄⁺ (ac) [eq. 3]

5. The method according to claim 4, further comprising:
grinding of the natural zeolite, sifting through sieves of 200 mesh and 120 mesh, and selection of the fraction with a particle size of less than 0.125 mm;
blending of the natural zeolite with a source of phosphorus in a proportion between 10 g (zeolite)/30 ml (solution) and 1 g (zeolite)/30 ml (solution) and stirring of the same for a period of between 5 and 15 minutes;
adjusting the pH of the mixture to values of between 8.5 and 10.0 inclusive, using an aqueous solution of NH₃ at 25%;
applying a thermal treatment at temperatures of between 15° C. and 170° C. inclusive, and during a period of between 0.5 and 120 hours inclusive;
separating the solid from the solution by filtrating and washing with distilled water, using a proportion of 1 litre of water to 2 g of solid; and
drying of the solid.

6. The method according to claim 5, wherein the temperatures in the application of the thermal treatment are equal to, or higher than, 60° C.

7. The method according to claim 5, wherein the temperatures in the application of the thermal treatment are less than 60° C. and equal to, or higher than, 40° C.

8. The method according to claim 5, wherein the temperatures in the application of the thermal treatment are less than 40° C. and equal to , or higher than, 15° C.

9. The method according to claims 5, wherein:
the natural zeolite is a natural stilbite zeolite, which is ground in a disc mill, and sieved to obtain particles of a size of between 0.074 and 0.125 mm;
the mixing of the natural stilbite zeolite with a source of phosphorus, which is dibasic ammonium phosphate [(NH₄)₂HPO₄] at a concentration of 1 M, at a proportion of 2 g (zeolite)/30 mL (solution) is performed in a polypropylene container and is stirred for 10 minutes;
the adjustment of the pH of the medium for the preparation of the composite material is performed at a value of 9.0, using an aqueous solution of NH₃ at 25%;
the application of the thermal treatment is performed during 19 hours at a temperature of 23° C.;
the separation of the solid from the solution is performed by vacuum filtration, and the washing with distilled water at a proportion of 1 litre of water for each 2 g of the solid obtained; and
the solid is air-dried.

10. The method according to claim 5, wherein:
the natural zeolite is a natural stilbite zeolite, which is ground in a disc mill, and sieved to obtain particles of a size of between 0.074 and 0.125 mm;
the mixing of the natural stilbite zeolite with a source of phosphorus, which is dibasic ammonium phosphate [(NH₄)₂HPO₄] at a concentration of 1 M, at a proportion of 2 g (zeolite)/30 mL (solution) is performed in a polypropylene container and is stirred for 10 minutes;
the adjustment of the pH of the medium for preparation of the composite material is performed at a value of 9.02, using an aqueous solution of NH₃ at 25%;
the application of the thermal treatment is performed during 6 hours at a temperature of 23° C.;
the separation of the solid from the solution is performed by vacuum filtration, and the washing with distilled water at a proportion of 1 litre of water for each 2 g of the solid obtained; and
the solid is air-dried.

11. The method according to claim 5, wherein:
the natural zeolite is a commercial clinoptilolite zeolite which is ground in a disc mill, and sieved to obtain particles of a size of between 0.074 and 0.125 mm;
the mixing of the commercial clinoptilolite zeolite with a source of phosphorus, which is dibasic ammonium phosphate [(NH₄)₂HPO₄] at a concentration of 1 M, at a proportion of 2 g (zeolite)/30 mL (solution) is performed in a polypropylene container and is stirred for 10 minutes;
the adjustment of the pH of the medium for preparation of the composite material is performed at a value of 9.02, using an aqueous solution of NH₃ at 25%,
the application of the thermal treatment is performed during 19 hours at a temperature of 23° C.;
the separation of the solid from the solution is performed by vacuum filtration, and the washing with distilled water at a proportion of 1 litre of water for each 2 g of the solid obtained; and
the solid is air-dried.

12. A method for removing fluoride from water, comprising:
contacting the composite material according to claims 1, with the water.

13. The method for removinc fluoride from water, according to claim 12, further comrpsising:
preparing of the composite material according to claim 4,
contacting and stirring the composite material and water bearing an initial concentration of fluoride of between 4 and 20 mg/L, and a pH of between 6 and 8.5, at a proportion of between 2 and 50 g of material per litre of water to be treated, for a period of time of between 0.5 and 20 hours; and
regenerating the composite material by means of treatment with a solution of NaOH at a pH of 11, stirred for a period of between 0.5 and 24 hours.

14. The method for removing flouride from water, according to claim 13, wherein:
the contacting and stirring of the composite material is performed with water bearing an initial concentration of fluoride of 10.8 mg/L, and a pH of 8, at a proportion of 10 g of material per litre of water to be treated, for a period of 19 hours; and
the regenerating of the composite material is performed with a solution of NaOH at a pH of 11, stirred for a period of 3 hours.
